(19) United States
(12) Patent Application Publication
(10) Pub. No.: US 2007/0198542 A1
(43) Pub. Date: Aug. 23, 2007

(54) Methods, systems, and computer program products for associating a persistent information element with a resource-executable pair

(76) Inventor: Robert Paul Morris, Raleigh, NC (US)

Correspondence Address: SCENERA RESEARCH, LLC;JENKINS, WILSON & TAYLOR, P.A., 3100 TOWER BLVD, SUITE 1400, DURHAM, NC, 27707, US

(21) Appl. No.: 11/351,142

(22) Filed: Feb. 9, 2006

(51) Int. Cl. G06F 7/00

(52) U.S. Cl. 707/100

(57) ABSTRACT

Methods, systems, and computer program products for a method for associating a persistent information element with a resource-executable pair are disclosed. According to one method, a computer system resource is associated with an executable to form a resource-executable pair. A persistent information element is associated with this pair. The persistent information element is stored independently from the resource and executable such that the persistent information element survives termination of a first instantiation of the executable. The method provides for performing an operation on or using the persistent information element with a second instantiation of the executable.

### TECHNICAL FIELD

The subject matter described herein relates to preserving resource state information in a host system. More particularly, the subject matter described herein relates to methods, systems, and computer program products for associating a persistent information element with a resource-executable pair.

### BACKGROUND

Application programs and other executables that run on computer systems have conventionally maintained all executable code and associated data values within predefined context bounds controlled by the resource or application. In some cases, the designers of application programs have defined data variables (called metadata variables) that may be stored in a persistent fashion; however, these variables are controlled by the application program and are not readily available to other programs or system resources. Similarly, metadata is sometimes associated with system resources. Metadata may be associated with a resource by storing the metadata in the resource, by storing the metadata in a file associated with the resource, by storing the metadata in a database, or by a combination of these methods. There is much metadata that is common across resources both of the same type and of differing types. Similarly there are desirable functions that are common across resources of the same type and different types which require the use of persistent data or metadata. Current computer systems require executables associated with the resources to be familiar with the specifics of how to access metadata from a variety of data storage means. As a result, applications that maintain or process data associated with a specific resource or group of resources must provide their own code to support this data access. Typically, applications don't maintain or process resource-specific data that is separate from the resource, at least not in a way that allows it to be shared with other applications.

For example it may be useful to maintain a counter for a resource or a resource group tracking the number of times it has been processed by an associated executable. Such a counter may be used for billing purposes, security purposes, or just for tracking purposes. Currently, an executable must provide its own counter requiring it to maintain storage for each resource or resource group it is associated with. Since the counters are provided in an executable-specific way, they are typically not available to other executables.

As a result, current computer systems inhibit the development of common functions that require persistent data maintained for a specific resource or group of resources. Such functions are integrated into numerous applications, separately leading to code bloat and duplicate code in addition to the problems described in the previous paragraph.

Another limitation on the operation of executables in conventional computer systems concerns the graphical user interface. In conventional systems, the context menu associated with a resource typically only provides menu items enabling an executable to be launched which takes the resource as input. For example, document files typically have an open context menu item that calls a word processing program with the document file provided as input. The context menu items have no standard mechanism which allows them to share data or process persistent data associated with a specific resource or resource group in a manner that is independent of the resource or the executable.

Yet another limitation on the operation of conventional computer systems pertains to automated actions related to events/operations associated with a resource or resource group. For example, conventional hosts may not explicitly provide the ability to permit the user to write or configure executables to implement predefined operations on the application software when started or ended. More specifically, a user might wish to autonomously open a specific spreadsheet or edit an image when opening a specific document with a word processing program. In conventional systems, the user would be required to open each desired program or data file manually. As a second example, a user might wish to automatically initialize certain data variables associated with a class or group of resources when operating on the resource or a member of the group with a specific executable associated with an application. In conventional systems, the user would be required to implement the desired changes to such variables manually for each resource instance. MICROSOFT WINDOWS desktop icons and properties, for example, require a user to know the command line syntax of an executable. Not all executable in this operating environment support command line input.

Conventional systems may include resources to facilitate data transfer from one open application to another through a common buffer. However, this common buffer is conventionally restricted to containing resources as data values, thus executables in the buffer may not be invoked from the common buffer. Further, this common buffer is treated as a temporary resource whose contents are not preserved in defined information structures for later use across reboots of the system. Also, this common buffer does not contain resources to autonomously store its contents to a persistent storage medium, resources to autonomously support user interfaces to permit external configuration of its contents, or resources to autonomously receive resource-related event notifications or autonomous control messages from applications that would either read or modify the contents of this common buffer.

Accordingly, in light of these difficulties associated with conventional preservation of resource state information in a host system, there exists a need for improved methods, systems, and computer program products for associating a persistent information element with a resource-executable pair.

### SUMMARY

According to one aspect, the subject matter described herein comprises methods, systems, and computer program products for associating a persistent information element with a resource-executable pair. One method includes associating a computer system resource with an executable to form a resource-executable pair. A persistent information element is associated with the resource-executable pair. The persistent information element is stored independently from the resource and the executable in a manner that survives termination of a first instantiation of the executable. The method includes providing for performing an operation on or using the persistent information element with a second instantiation of the executable.

As used herein, the term “resource” refers to a unit of data accessible by a computer system, including a file, a file folder, or any other data unit. The term “executable” refers to a system resource that includes instructions that can be executed by a processor. The term “persistent information element” refers to a unit of data than can be associated with a resource-executable pair and stored in persistent storage. Examples of persistent information elements include input data variables, output data variables, and classes that include executable and non-executable elements. Input and output data variables include input and output parameters, static variables, constants, etc. and are not restricted to data passed at the invocation of an executable or to the intended output of an executable.

A resource-executable pair may also be a resource-class pair if the executable is a member of class that is paired with the resource. In addition, a resource group may be associated with an executable to form a resource group-executable pair. A resource group may also be associated with a class to form a resource group-class pair. Any of these pairings may be associated with a persistent information element without departing from the scope of the subject matter described herein.

The subject matter described herein associating a persistent information element with a resource-executable pair may be implemented using a computer program product comprising computer executable instructions embodied in a computer-readable medium. Exemplary computer-readable media suitable for implementing the subject matter described herein include chip memory devices, disk memory devices, programmable logic devices, application specific integrated circuits, and downloadable electrical signals. In addition, a computer-readable medium that implements the subject matter described herein may be distributed as represented by multiple physical devices and/or computing platforms.

### BRIEF DESCRIPTION OF THE DRAWINGS

Preferred embodiments of the subject matter described herein will now be explained with reference to the accompanying drawings of which:

FIG. 1 is a flow chart illustrating an exemplary process for associating computer system resources, executable files, and persistent information elements according to an embodiment of the subject matter described herein;

FIG. 2 is a block diagram of a host system architecture comprising an exemplary association library containing executable files and persistent information element data values, an exemplary persistent information element data storage medium, and exemplary system resources according to an embodiment of the subject matter described herein;

FIG. 3 is a diagram illustrating an exemplary graphical user interface (GUI) with an application pane containing multiple files and folders along with a context menu and submenu, where the context menu contains both locally active commands and commands that operate on an exemplary association library according to an embodiment of the subject matter described herein;

FIG. 4 is a block diagram illustrating exemplary data structures and linkages which contain resource-executable pair definitions and persistent information elements within an exemplary association manager according to an embodiment of the subject matter described herein;

FIG. 5 is a block diagram illustrating an exemplary detailed internal data records and linkages among the exemplary data structures recited in FIG. 4 according to an embodiment of the subject matter described herein;

FIG. 6 is a flow chart illustrating an exemplary process for creating logical associations among persistent information elements and resource-executable pairs to be maintained by an exemplary association manager according to an embodiment of the subject matter described herein;

FIG. 7 is a flow chart illustrating an exemplary process for creating persistent information element data value and type definitions in an exemplary association manager according to an embodiment of the subject matter described herein;

FIG. 8 is a flow chart illustrating an exemplary process for registering an executable file and establishing appropriate resource-executable pair assignments in an exemplary association manager according to an embodiment of the subject matter described herein;

FIG. 9 is a flow chart illustrating an exemplary process for creating a class definition among resource-executable pairs, persistent information data values, and other class definitions according to an embodiment of the subject matter described herein; and

FIG. 10 is a flow chart illustrating an exemplary process for an event handler operating within the association library according to an embodiment of the subject matter described herein.

### DETAILED DESCRIPTION

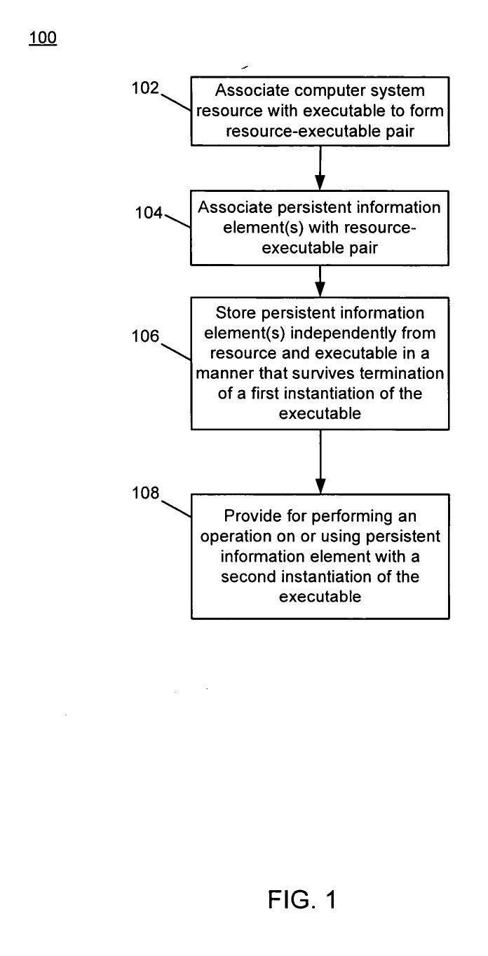

In view of the problems described above with respect to a lack of a framework for support of persistent information elements for resource-executable pairs in conventional systems, the subject matter described herein provides a method for associating persistent information elements with a resource-executable pair. FIG. 1 illustrates an exemplary host process 100 for associating persistent information elements with resource executable pairs and for operating on or using the persistent information element with multiple instantiations of an executable according to an embodiment of the subject matter described herein. Process 100 may be instantiated and run on a host computer system in conjunction with other system applications and to utilize system level resources and functions on the host system when required.

In FIG. 1, at block 102 a computer system resource may be associated with one or more executables. This association may be implemented using any mechanism that supports logical linkage, such as a database or link table. The executable may either be stored within the host system or at a remote site. The association definition may be maintained at the host computer system, and a copy of the definition may be placed on a secondary persistent data storage medium in the host system.

At block 104, the resource-executable pair defined at block 102 may be associated with one or more persistent information elements. The persistent information elements may be any data values or data structures that are of some use to the resource or executable to which the persistent information elements are linked. As with the resource-executable association, the persistent information element link to the resource-executable pair may be implemented using any suitable linkage mechanism, including databases or linked list tables.

At block 106, the persistent information element(s) associated with the resource-executable pair may be stored in an area of the host system memory architecture such that the persistent information element contents survive termination of a first instantiation the executable. For example, the persistent information elements may be stored on a secondary persistent data storage medium, such as a disk drive, floppy, compact disk (CD), digital versatile disk (DVD), a persistent memory, or the like.

At block 108, the computer system provides for an operation to be performed on or using the persistent information element with a second instantiation of the executable. For example, if the persistent information element is an instantiation counter associated with a document-word processor pair, the counter may be incremented the first time the document is opened using the word processor and may survive termination of the word processor. The second time the document is opened using the word processor, the counter may add 1 to its persistently stored value. Alternately or additionally, an instantiation of an executable of a resource-executable pair produce a value, which is stored as a persistent information element which may then be used by an instantiation of another executable which may or may not be associated with the resource.

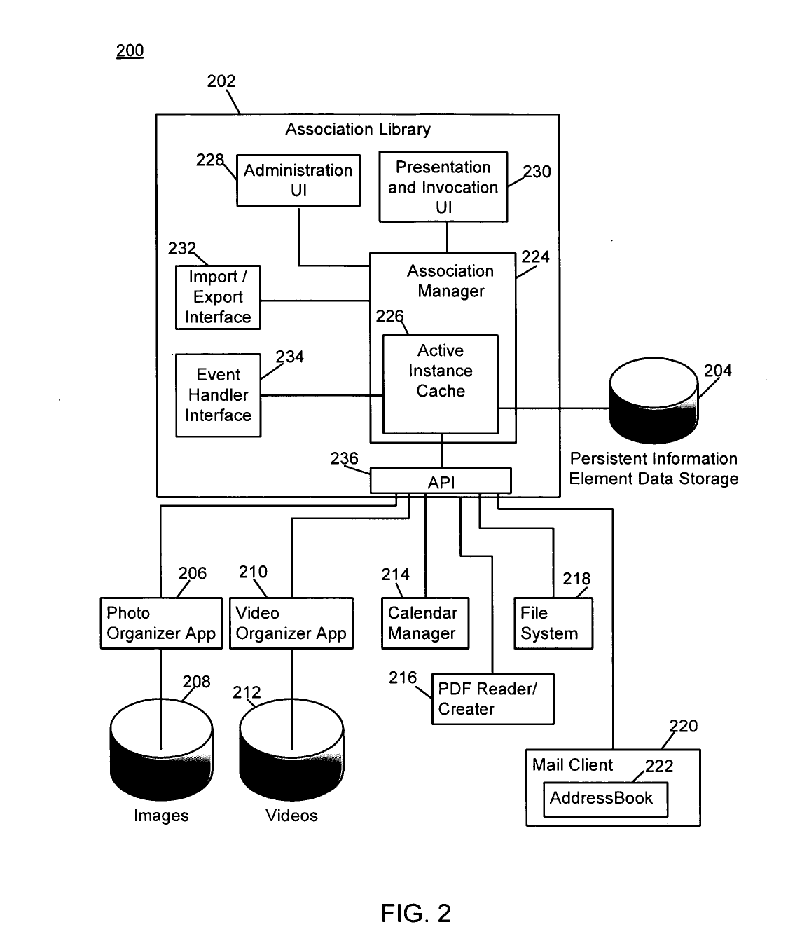

FIG. 2 illustrates an exemplary host system 200 with an exemplary association library 202 containing persistent information elements and exemplary persistent information element data storage medium 204. In FIG. 2, host system 200 may also include one or more system resources including photo organizer 206 and image database 208, video organizer 210 and video database 212, calendar manager 214, PDF reader/creator 216, file system 218, or mail client 220 with embedded address book manager 222.

Association library 202 may contain an association manager 224 which may store association assignments among resources, executables, and persistent information element(s). Other functions that may be implemented by association manager 224 include: storage and retrieval of executables or references to executables; storage and retrieval of persistent information elements and classes; creation and registration of new executables, references to executables, persistent information elements, and classes; maintenance of pre-assigned associations among executables, persistent information elements, and classes; determination of property references for executables; and tests for compatibility of resource-executable associations. Association manager 224 may include an active instance cache 226 to keep recently accessed or active copies of resource-executable associations and persistent information element associations and values for applications that are active in the host system. Association manager 224 may also contain functions to directly manage an external persistent information element data storage medium 204, which may be used by association manager 224 to store a copy of the information in association library 202.

Association library 202 may contain a series of external graphical user interface (GUI) resources to manage transfers of data in the association manager 224 to a variety of external processes. An administration user interface (UI) function 228 may be provided to permit a user to search the contents of association manager 224 for specific resources, executables, class definitions, or assigned associations. Administrative UI interface 228 may contain resources to permit a user to create, modify, or delete content within association manager 224. A separate presentation and invocation UI function 230 may be provided to implement some of the modification operations defined by association manager 224 on its contents. These UI functions may implement or enforce data structure conventions that convey significance or meaning to host computer system 200 or association manager 224.

Association library 202 may include an interface function 232 to support file import or export operations. An import function associated with interface function 232 may accept persistent information element or association definitions into association library 202, which association manager 224 may validate and subsequently incorporate. An export function associated with interface function 232 may collect preselected association definitions from association manager 224 and then package the contents for transfer to an external destination. File structure definitions for import and export operations may be defined by the association manager using any format that conveys meaning to association manager 224 or host computer system 200.

Association library 202 may contain an event handler interface 234 to receive resource-related event messages for association manager 224 and assist association manger 224 with any required responses to resource-related event messages. Resource-related event management may also be bound into class definitions maintained in association manager 224.

Association library 202 may provide an application programming interface (API) 236 to permit resources and applications running on the host system to access association manager 224 to read or modify the contents of resource definitions controlled by association manager 224. Active resources or application programs may interact with association manager 224 through API 236 to create, modify, or delete associations, persistent information elements, executables, or references to executables.

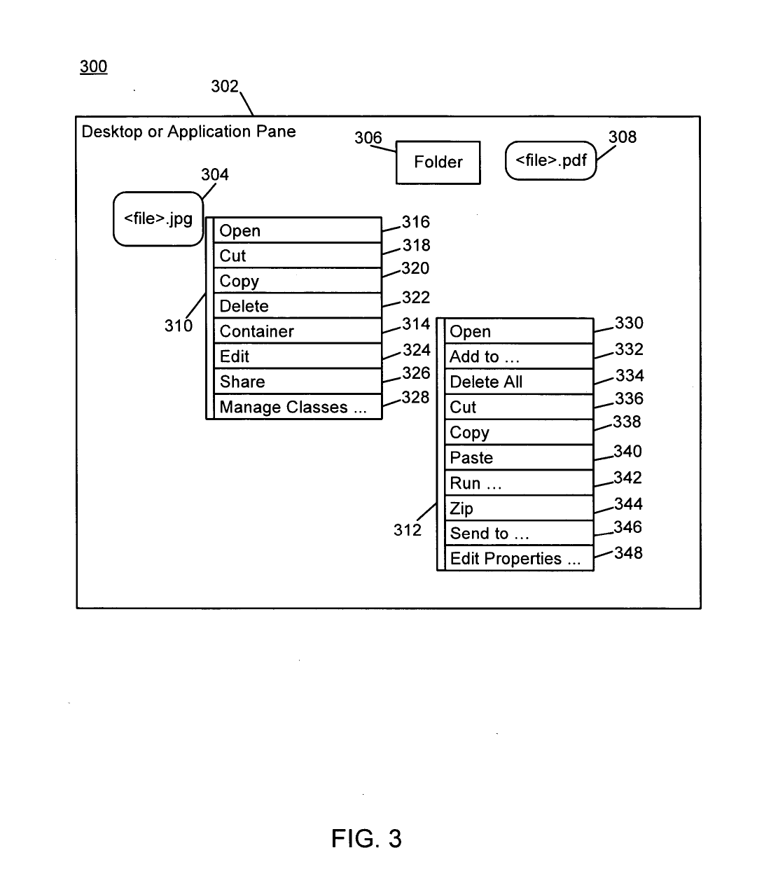

FIG. 3 shows an exemplary GUI 300 with an application or desktop pane 302 containing a JPEG file 304, a system folder 306, and a PDF file 308. Two exemplary pull-down context menus are also shown in pane 302: a context menu 310 for JPEG file 304, and a context sub-menu 312 for container class tab 314 in context menu 310.

In FIG. 3, context menu 310 may contain tabs for containing links to a variety of functions supported by the active JPEG resource, as well as to predefined methods and contents of association manager 224 which are outside the control domain of the JPEG application. For example, an open tab 316, a cut tab 318, a copy tab 320, and a delete tab 322, in menu 310 may contain links to procedures that operate within the local context of the JPEG file and associated application software. That is, they apply to the resource itself. Likewise, a container tab 314, an edit tab 324, a share tab 326, and a manage classes tab 328 in menu 310 may be locally accessible but contain links to procedures that operate on contents of an association manager 224.

Links to procedures in menu 310 for JPEG file 304 may provide conventional functions. For example, open tab 316 may provide a mechanism to open the associated JPEG file using the default application specified in the system. Cut tab 318 may provide a mechanism to delete the selected JPEG file from the pane or desktop and place it in the system clipboard. Copy tab 320 may provide a mechanism to copy the JPEG file to the system clipboard. Delete tab 322 may provide a mechanism to remove the JPEG file from the system or place it in the system “trash” folder.

In addition to the conventional functions, context menu 310 may contain menu items or tabs that access or create associations between resource-executable pairs and persistent information elements. For example, edit tab 324 in context menu 310 may identify an executable associated with the JPEG file resource forming a pair allowing specification of a project identifier to be associated with the resource-executable pair through the persistent information element contents and associations located in association manager 224. For example, for the given JPEG file, the projects identified may be an electronic postcard project. Each project may be defined as a workflow process in which the edit executable tracks the state of the workflow. When selected, edit tab 324 may cause a tool appropriate for the stage of the project workflow to be invoked, and the host system may display a separate pop-up GUI for operations within the context of the command environment for an edit operation.

Share tab 326 in context menu 310 may have associated property instances for the resource-executable pair formed by the tab's executable and the context menu's resource to enable sharing of the resource and track where the resource has been shared. Its properties may be pre-configured with a list of media sharing services and other access information to permit selection of one or more sharing services for the file as well as definition of permitted sharing of the file through the selected services. When selected, share tab 326 may cause the host system to display a separate pop-up GUI for operations within the context of the command environment for a share operation.

Manage classes tab 328 in context menu 310 may invoke a UI and methods to modify the persistent information elements and association definitions maintained in association manager 224 in which the specified resource participates, including addition, deletion, or modification of executable, property, or class assignments. This tab may also provide access to a separate GUI and methods to define persistent property instances and the executables or classes to which they may be associated.

A container tab 314 may provide a link to a class associated with the active resource, as defined in association manager 224. A class may be thought of as a group of related executables, thus a resource-class pair is a group of related resource-executable pairs. Executables in a class typically work together and share data including persistent information elements. Upon selection of this tab, a context submenu 312 with additional functional tabs may be displayed on the GUI, as shown in FIG. 3. The tabs in submenu 312 may then contain links to methods/executables assigned to a container class associated with the JPEG resource.

An open tab 330 in context submenu 312 may cause association manager 224 to display the contents of the referenced container class. Thus, the container's persistent information elements create a relationship between the JPEG file and the elements of the container class. This relationship allows events associated with the JPEG file and with the container elements to affect one another through event handlers. The container class also provides a means by which any resource may be made a node in a navigation structure. Tab 330 may cause the contents of the container associated with the resource to be displayed, including references to a list of contained resources, filter(s) that indicate the type of resource(s) it may contain, and/or a count of the number of resources in the container. Alternately, a user specified default executable may be associated with the “Open” menu item.

An “Add to” tab 332 in context submenu 312 may permit additions to be made to the referenced container resource-class pair's persistent information elements in association manager 224. That is, the add tab 332 may permit additional resources to be added to the container of the resource-class pair.

A delete all tab 334 in context submenu 312 may permit association manager 224 to remove all references to resources in the container class of the resource-container pair.

A cut tab 336 in context submenu 312 may permit association manager 224 to delete selected associations of the container class of the resource-class pair while maintaining container class references to other resources.

A copy tab 338 in context submenu 312 may permit a copy of selected contents of the container class of the resource-class pair to be stored in a temporary data buffer in the host system without altering the contents of the class.

A paste tab 340 in context submenu 312 may permit additions to be made to container class resource references from a temporary data buffer in the host system.

A run tab 342 in context submenu 312 may cause association library 202 to display a pop-up window on the GUI with methods to permit additional operations to be defined on the contents of the container class of the resource-class pair.

A zip tab 344 in context submenu 312 may cause the host system to copy the contents of the container class of the resource-class pair to an independent file and then compress that file using a conventional file compression resource.

A send to tab 346 in context submenu 312 may permit the host system to copy the contents of the container class of the resource-class pair to an independent file and then transfer that file to a remote destination using a conventional file transfer resource.

An edit properties tab 348 in context submenu 312 may display persistent information elements representing properties of the container class of the resource-class pair and provide methods for modifying these properties. Association manager 224 may control access to the persistent information elements and may determine which persistent information elements may only be read and which may be read or modified.

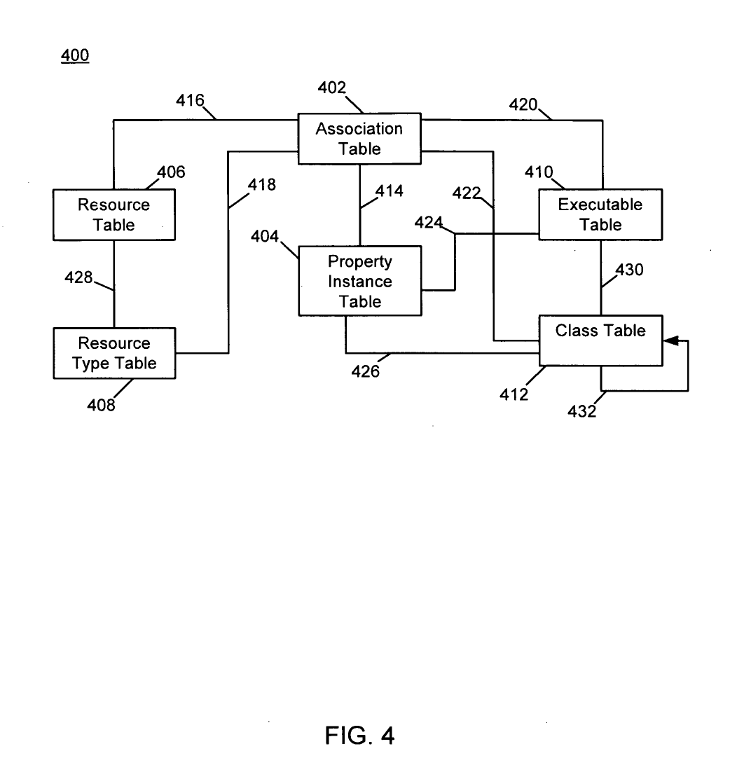

FIG. 4 presents an exemplary data structure 400 to contain resource-executable pair and persistent information element associations within an exemplary association manager 224. In FIG. 4, contents of association manager 224 may be distributed among an association table 402, a property instance table 404, a resource table 406, a resource type table 408, an executable table 410, and a class table 412. Association table 402 may be linked to property instance table 404 as represented by logical connector 414, to resource table 406 as represented by logical connector 416, to resource type table 408 as represented by connector 418, to executable table 410 as represented by logical connector 420, and to class table 412 as represented by logical connector 422.

Association table 402 may contain a series of records, each showing associations among executable and resource, and executables and classes. That is, it maintains the resource-executable pairs which including resource-class pairs. Linkages to resources referenced in resource table 406 are made through logical connector 416. Linkages to groups or resources such a resources grouped by type may be made as illustrated by logical connector 418 linking association table 402 and resource type table 408. It is easy to imagine other mechanisms for grouping resources. Thus, the system supports resource group-executable pairs and, hence, supports resource group-class pairs. Association table 402 linkages to executables in executable table 410 and classes in the class table 412 are made through logical connectors 420 and 422, respectively. Logical connector 432 linking records in the class table 412 to other classes in the class table 412 provide support for single and or multiple inheritance depending upon the embodiment.

Property instance table 404 may contain persistent information elements and/or references to persistent information elements for resource-executable pair assignments contained in association table 402. Each persistent information element may have a record in a table that matches its property type, and property instances may be part of zero or more resource-executable associations. Classes, executables, and groups of resources are system resources that may be referenced in property tables 404, and thus may be used as properties for resource-executable pairs.

As mentioned resource table 406 may contain records of accessible resources. Each defined resource may be part of a group classified by resource type and thus associated with a resource type record. Resources may be classified by attributes other than type. Hence, resource table 406 may contain logical linkages to resource type table 408 as represented by logical connector 428.

Resource type table 408 may contain a list of resource type assignments, allowing Resources to be used collectively as a group through reference to resource type information as well as individually through direct reference to the resource name as previously discussed. A resource type definition may be part of zero or more associations.

An executable table 410 may be provided in association manager 224 to contain executables or references to executables stored outside association library 202. If an executable is maintained outside association library 202, it may be referenced in executable table 410 with a pointer specified by a name, by a path definition through a local file server, or by a uniform resource locator (URL) address. Each entry in executable table 410 may also contain a descriptor identifying compatible resources and/or resource types. An executable may be part of zero or more associations. Hence, executable table 410 may contain logical linkages to property instance table 404 as represented by logical connector 424.

Class records may be stored in a class table 412. A class may be defined by executables that it contains as well as by its parent(s) class(es), with the executables identifying any required property references. Static property data definitions may be contained in the class record itself, and relationships to executables may be classified as static in the class records as well. A class may be associated with zero or more associations. Hence, class table 412 may contain logical linkages property instance table 404 via logical connector 426 to identify its static properties, executable table 410 via logical connector 430 to identify its executable members, and to parent classes, if any, within class table 412 via logical connector 432.

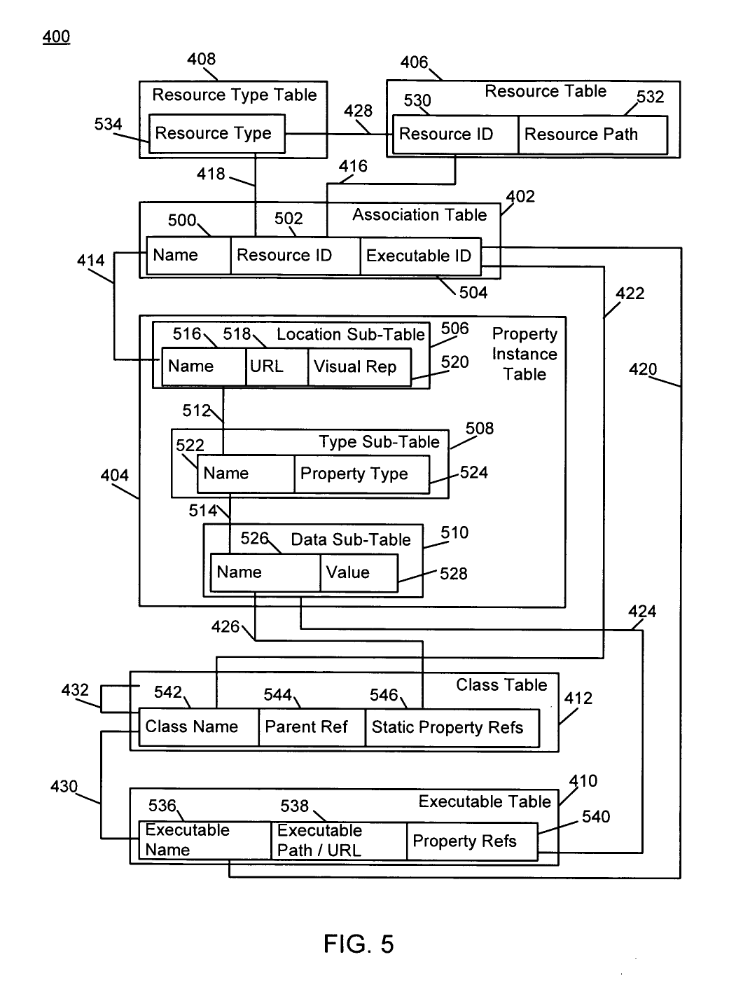

FIG. 5 is a block diagram illustrating exemplary detailed internal data records and linkages within exemplary data structure 400 for association manager 224. In FIG. 5, association table 402 may contain a series of data records, one for each resource-executable pair defined and managed by association manager 224. Each record in association table 402 may contain multiple fields, including association name 500, resource identifier 502 which may be a resource group identifier, and executable identifier 504 which may be a class identifier. The content and format of these fields may be defined in any manner that conveys significant meaning to host system 200 and to association manager 224. Logical connector 418 may represent a linkage between resource identifier 502 and resource type table 408, while logical connector 416 may represent a linkage between resource identifier 502 and resource table 406. Logical connector 420 may represent a linkage between executable identifier 504 and executable table 410, while logical connector 422 may represent a linkage between executable identifier 504 and class table 412. The contents of the various fields and records within association table 402 may be of any format significant to host computer system 200 and to association manager 224.

Property instance table 404 may be further partitioned into sub-tables to simplify organization of pertinent association information for persistent information elements to be stored in association manager 224. These sub-tables may include a persistent information element location sub-table 506, a persistent information element type sub-table 508, and a persistent information element data sub-table 510. These sub-tables, in turn may each be organized as a series of records, and they may be linked within table 404 using interior logical connectors 512 and 514. The contents of the various fields and records within the sub-tables of property instance table 404 may be of any format significant to host computer system 200 and to association manager 224.

Each record in location sub-table 500 may contain fields for persistent information element name 516, URL 518 allowing the element to be maintained locally or at a remote server, and a pointer 520 to a visual graphic representation if appropriate. Sub-table 506 Name field 516 may be linked to association table 402 as represented by logical connector 414 and to type sub-table 508 as represented by logical connector 512.

Each record in type sub-table 508 may include fields for persistent information element name 522 and property type information 524. Name field 522 of type sub-table 508 may be linked to location sub-table 506 as represented by logical connector 512 and to Sub-Table 510 as represented by logical connector 514.

Each record in data sub-table 510 may include fields for persistent information element name 526 and value 528. Additional attributes of each data element may be kept in separate fields or tables (not shown). For example, the scope of a persistent information element may be defined as public, private, or protected to a class. A persistent information element may also be defined as being a read-only value, a write-only value, or a read/write value. Data sub-table 510 name field 526 may be linked to class table 412 as represented by logical connector 426, to executable table 410 as represented by logical connector 424, and to type sub-table 508 as represented by logical connector 514.

Resource table 406 may contain a series of data records, one for each Resource managed by association manger 224. Each record in Table 406 may contain fields for a resource identifier 530 and a pointer 532 to the resource in host computer system 200. The resource ID field 530 within each record may be linked to resource type table 408 as represented by logical connector 428, and may be linked to association table 402 as represented by logical connector 416. The contents of the fields within Resource table 406 may be of any format significant to host computer system 200 and association manager 224.

Resource type table 408 may contain a series of data records 534, each of which contains a detailed type definition for resources available on host computer system 200. Each resource type record 534 may be linked to resource table 406 as represented by logical connector 428 and may be linked to association table 402 as represented by logical connector 418. The contents of resource type records 534 may be of any format significant meaning to host system 200 and association manager 224.

Executable table 410 may contain a series of data records, one for each executable managed by association manager 224. Each record in table 410 may contain fields for executable name 536, a pointer for the executable file 538, and any property references 540. Executable pointer field 538 may contain URL address for an Internet server or may contain a pointer to an executable maintained in the host computer system. Executable name field 536 in each record may be linked to class table 412 as represented by logical connector 430 and may be linked to association table 402 as represented by logical connector 420. Similarly, the property references field in each record may be linked to property instance table 404 as represented by logical connector 424. The contents of executable table 410 record fields may be of any format significant to host computer system 200 and association manager 224.

Class table 412 may contain a series of records, one for each class controlled by association manager 224, to define class associations among resource-executable pairs and persistent information elements. Each record may contain fields for class name 542, a pointer to a parent class definition 544, and a list of static property references for the class 546. Class name field 532 in each record may be linked to executable table 410 as represented by logical connector 430, to association table 402 as represented by logical connector 422, and to other class definition records within class table 412 as represented by logical connector(s) 432. Static property reference field 546 in each record may be linked to property instance table 404 as represented by logical connector 426. The contents of class table 412 record fields may be of any format significant to host computer system 200 and association manager 224.

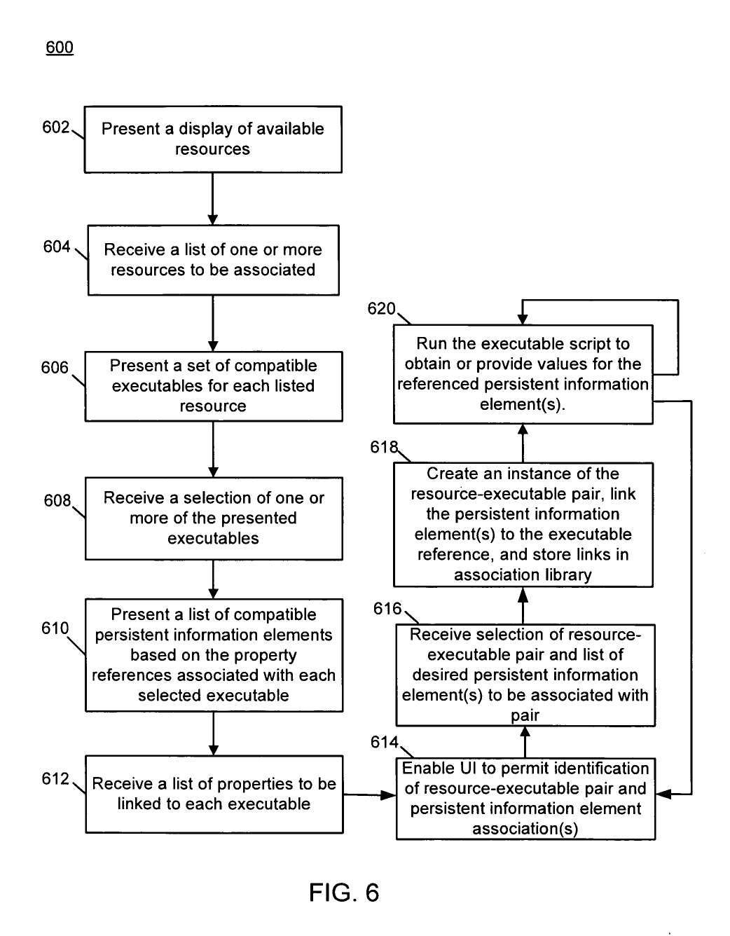

FIG. 6 illustrates an exemplary process 600 for permitting an external user to create logical associations among persistent information elements and resource-executable pairs to be maintained by an exemplary association manager. These definitions may be provided through an appropriate UI function in association library 202, using any data formats considered meaningful to either association manager 224 or host computer system 200. Process 600 may be readily extended to permit use of file import or export functions through import/export interface 232 of association library 202.

In FIG. 6, at block 602, association manger 224 may present a list of currently available system resources registered in resource table 406 upon request. Association manager 224 may optionally present the resource type information associated with each displayed resource, as listed in resource type table 408.

At block 604, association manager 224 may receive a list of resources selected by an external user for further processing. Association manager 224 may validate the received list of resources against the contents of resource table 406 and resource type table 408.

At block 606, association manager 224 may present a list of executables which have been predefined for use with the selected resource(s) identified at block 602. Property reference fields 540 in executable table 410 records may be parsed to derive a list of compatible executables presented at block 606.

At block 608, association manger 224 may receive a list of executables selected by an external user from the list presented at block 606. Association manager 224 may validate the received list of executables against the contents of executable table 410.

At block 610, association manager 224 may present a list of persistent information elements compatible with the list of resource(s) received at block 604 and the list of executable(s) received at block 608. Property type fields 524 within type sub-table 508 of property instance table 404 may be parsed to derive a list of compatible executables presented at block 610.

At block 612, association manger 224 may receive a list of persistent information elements selected by an external user from the list presented at block 610. Association manager 224 may validate the received list of persistent information elements against the contents of property instance table 404 and associated sub-tables.

At block 614, association library 202 may enable an external user to define any desired associations between a selected resource, a compatible executable, and any compatible persistent information element(s).

At block 616, association manager 224 may receive a resource-executable pair definition and a list of persistent information elements to be associated with the resource-executable pair.

At block 618, association manager 224 may capture the resource-executable pair definition and persistent information element associations received at block 616. A new record may be created within association table 402 identifying the desired resource-executable pair, capturing an association name, resource identifier, and executable identifier as field entries in the new record. Appropriate links to property instance table 404, resource table 406, resource type table 408, executable table 410, and class table 412 may also be instantiated by the association manager 224 at block 618.

At block 620, association manager 224 may instantiate the executable identified at block 618, in order to either initialize each persistent information element or retrieve the data value for each persistent information element associated with the executable at block 618. Process 600 may then allow a return to block 614 to determine if resource-executable assignments are to be added to association manger 224, or process 600 may allow step 620 to be repeated.

Alternately, or in addition to blocks 610 and 612, previously described descriptors associated with executables may provide information enabling the association manager to create and optionally initialize persistent property elements required by the executable when part of a resource-executable pair. The user may override these defaults as blocks 610 and 612 describe.

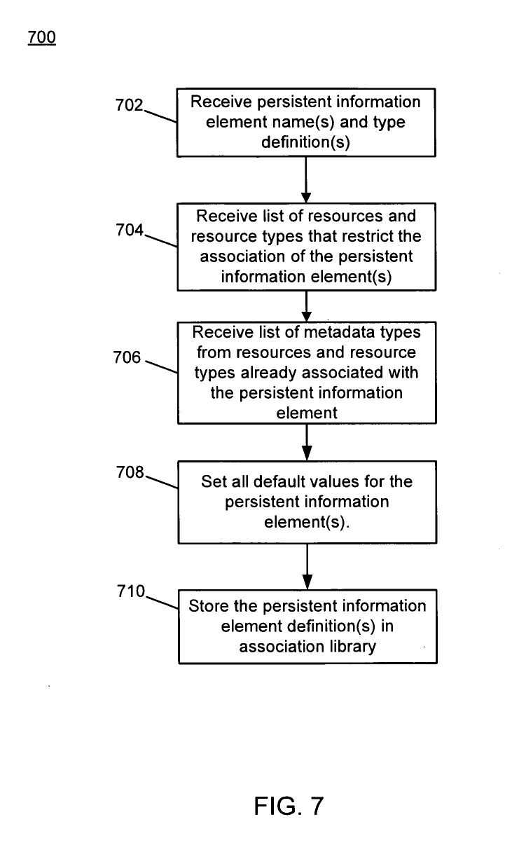

FIG. 7 illustrates an exemplary process 700 for permitting an external user to create persistent information element data value and type definitions according to an embodiment of the subject matter described herein. These definitions may be provided through an appropriate UI function in association library 202, using any data formats considered meaningful to either association manager 224 or host computer system 200. Process 700 may be readily extended to permit use of file import or export functions through import/export interface 232 of association library 202.

In FIG. 7, at block 702, association manager 224 may receive a list of names, type definition, and associated information for a new persistent information element from an external user. The persistent information element type definition may also include properties, including an indication of the scope of the persistent information element and whether it is to be considered a read-only variable, a write-only variable, or a read/write variable.

At block 704, association manger 224 may receive a list of specific resources which are allowed to make use of the persistent information element identified at block 702. Association manger 224 may also run a validation check to confirm that the type definitions for the identified resources are compatible with the persistent information element type definition received at block 702, and block use of persistent information elements whose type assignments are not compatible with the listed resource(s).

At block 706, association manger 224 may receive a list of metadata variables managed within the resource context whose values are to be linked to specific persistent information element(s) identified at block 702.

At block 708, association manager 234 may set default values for the new persistent information element(s) identified at block 702. This method may include copying values of resource metadata variables identified at block 706 into corresponding persistent information elements.

At block 710, association manager 224 may create new records in sub-tables of property instance table 404 to capture definitions for the new persistent information element(s). Location sub-table 506 may be updated with a new record whose subfields are populated with the persistent information element name, an URL, and a pointer to an appropriate visual representation as identified by an external user at block 702. Type sub-table 508 may be updated with a new record whose subfields are populated with the persistent information element name and property type definitions received at block 702. Data sub-table 510 may be updated with a new record whose subfields are populated with the persistent information element name received at block 702 and with data values received either from an external user at block 702, from resource metadata definitions at block 708, or from variable default assignments as defined by association manager 224 or host computer system 200. Association links between the new records in property instance table 404 and association table 402, executable table 410, and class table 412 may also be instantiated at block 710.

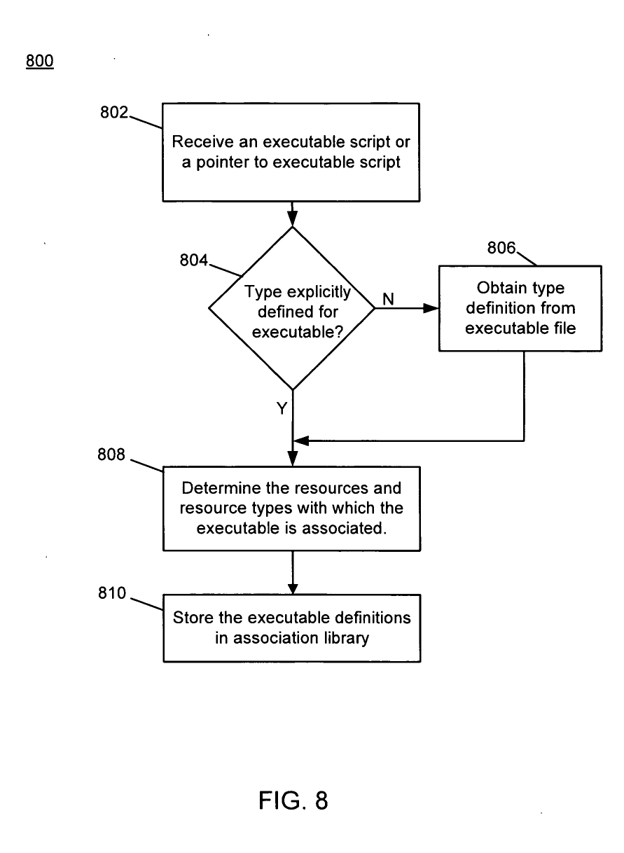

FIG. 8 illustrates an exemplary process 800 for permitting an external user to register an executable file and establish appropriate resource-executable pair assignments according to an embodiment of the subject matter described herein. Executables may be implemented using any program or scripting language supported by association library 202 and host computer system 200. These definitions may be provided through an appropriate UI function in association library 202, using any data formats considered meaningful to either association manager 224 or host computer system 200. Process 800 may be readily extended to permit use of file import or export functions through import/export interface 232 of association library 202.

In FIG. 8, at block 802, association manger 224 may receive a definition for an executable to be registered, along with a list of resources or persistent information elements to which it may be associated. This definition may be the executable itself or a pointer to an executable located in the host computer system, or a URL address to an executable located on a remote server. Alternatively, an executable name and description may be submitted and stored.

At decision point 804, the information received at block 802 may be reviewed for an explicit type definition for the executable. If a type definition is presented with the executable, the method proceeds directly to block 808. Otherwise, at block 806, association manager 224 may instantiate the executable or access the server maintaining the executable in order to obtain the type definition.

At block 808, association manager 224 may derive a list of resource(s) and resource type(s) that may be associated with the new executable. This operation may be implemented by parsing the contents of resource type table 408 to obtain corresponding resource names maintained in Resource table 406.

At block 810, association manager 224 may create a new record in executable table 410 and populate the fields with appropriate name, pointer, and property type definitions. Appropriate links with property instance table 404, class table 412, and association table 402 may be instantiated as well.

Related executables and associated persistent information elements may be organized into formal classes. Loadable class instances may be associated with any compatible resource or category of resources. Alternate embodiments may be created without using formal class structures, as a collective definition of associations between persistent information elements or executables with references to persistent information elements that may be associated directly with a resource or collection of resources. While the preferred embodiment may group executables and property references into “class”-like structures, alternate language may be used to implement the executable reference for accessing required persistent information element data, other executables, or class members if supported by association manager 224. Association library 202 may support executables in a class implemented using a mixture of languages and platforms or executables in a class defined only using name/value strings.

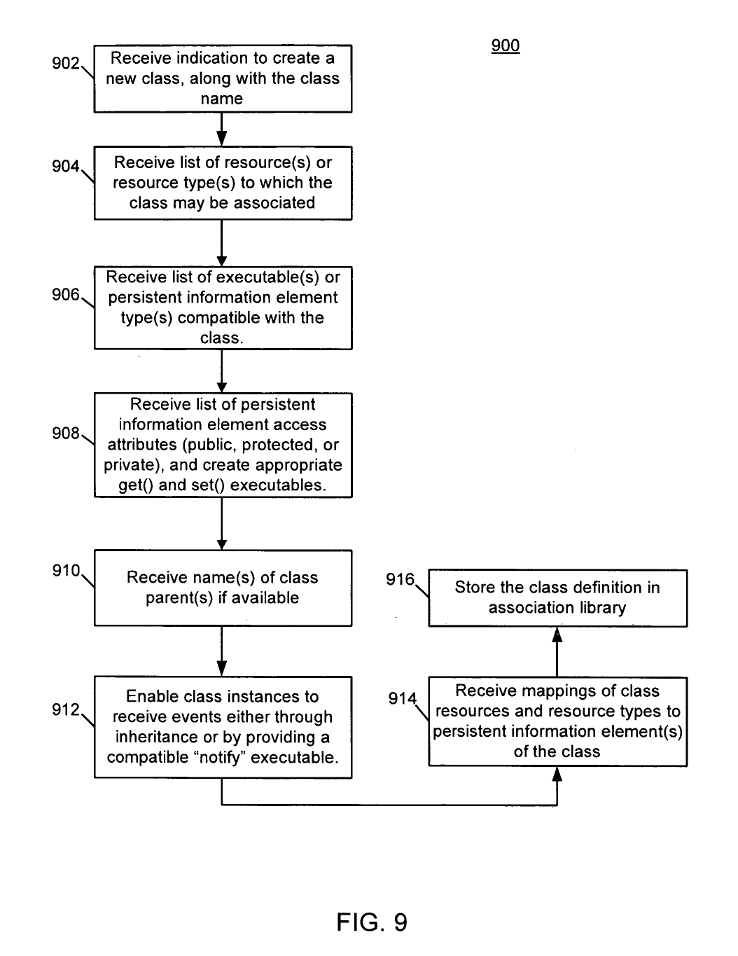

FIG. 9 illustrates an exemplary process 900 for permitting an external user to create a class definition utilizing persistent information elements and resource-executable pairs or other classes according to an embodiment of the subject matter described herein. A process to modify an existing class definition may follow a similar sequence. These definitions may be provided through an appropriate UI function in association library 202, using any data formats considered meaningful to either association manager 224 or host computer system 200. Process 900 may be readily extended to permit use of file import or export functions through import/export interface 232 of association library 202.

In FIG. 9, at block 902, association manager 224 may receive a request from an external user to create a new class definition, along with a name for the new class. Association manager 224 may create a new record in class table 412 for the requested class, and populate class name field 542 in the new record.

At block 904, association manager 224 may receive a list of resources or resource types from an external user to be defined within the class structure. Association manager may validate the received list against the contents of resource table 406 and resource type table 408.

At block 906, association manager 224 may receive a list of executables or persistent information elements to be associated with the resources or resource types defined for the class. Association manager 224 may validate compatibility between resource(s) and requested executable(s) and between resources and requested persistent information element(s). Association manager 224 may update the record in class table 412 to capture links between the new class definition and the validated list of executables to be associated with the new class.

At block 908, association manager 224 may receive a list of persistent information element access attributes. Such attributes may define each persistent information element as being public, private to the class, or protected (read-only). Based on the received access attributes, association manager 224 may create local data management executables including Get( ) and Set( ). Association manager 224 may update record for the new class in class table 412, capturing the persistent information element access references.

At block 910, association manager 224 may receive a list of parent class(es) from which the new class may inherit members or attributes. Association manager 224 may implement a checking procedure to validate compatibility between attributes of the new class and corresponding attributes in the parent class(es), and may override parent class attributes. Association manager 224 may also update the record for the new class definition in class table 412, populating the field(s) containing pointers to the identified parent class(es).

At block 912, association manager 224 may extend class definitions to support processing of resource-related events received by association library 202 at event handler interface 234. Definitions and methods for resource-related event processing may be received into the new class from parent class(es) or by providing a compatible “notify” executable optimized to meet the requirements of the host computer system.

At block 914, association manager 224 may receive a list of mappings between class resources and class resource types to class persistent information element(s). Association manager 224 may validate compatibility of the requested linkages, and then instantiate class table 412 link assignments with association table 402 and property instance table 404.

Association library 202 may provide a mechanism allowing an executable instance to be notified when resource-related events related to the associated resource occur and, thus, respond in a manner specific to the resource and the state of the executable instance. This may allow the user to automate his/her system, and, in particular, update the properties of the resource/executable association based on resource-related activity. Events associated with a resource supported by the preferred embodiment may include access by an application, selection, reception of focus, mouse over, copy, move, delete, timer events, or access by a specific user or group. For example, when a word processor is opened, an associated executable instance configured to receive events associated with the word processor resource may cause a GUI pane to be displayed with all available system resources that are compatible with the word processor. Or if a file is opened, an automatic executable that causes all available resources associated with the file through a project relationship may be presented to the user for easy access.

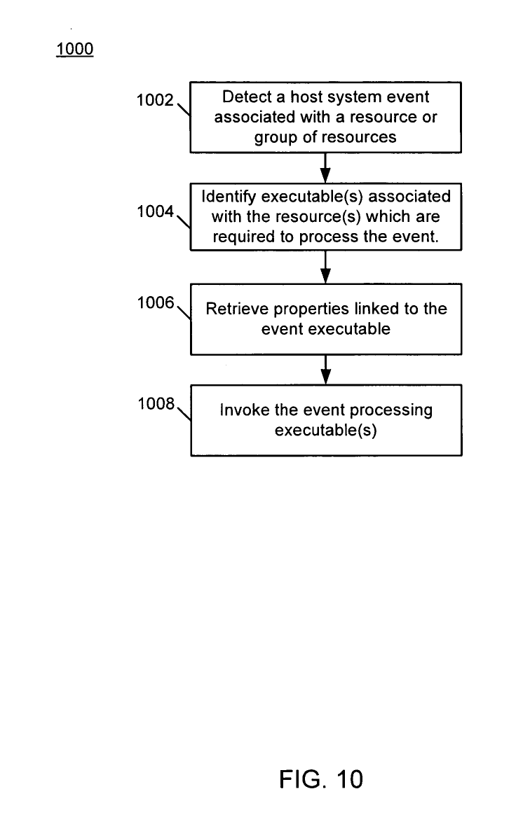

FIG. 10 illustrates a process 1000 for an event handler operating within the association library. In FIG. 10, event handler interface function 234 may interact with the host computer system to receive system and/or user event notifications and to generate appropriate response message(s) according to an embodiment of the subject matter described herein. Processing of received events may be coordinated by resource-related event processing methods or resources identified in class definitions as listed in class table 412, as denoted by exemplary process 1000.

At block 1002, an event notification may be presented to association manager 224. The event notification may contain an event ID, a resource ID of an impacted resource, and/or a resource group ID of an impacted resource group.

At block 1004, a list of executables associated with the resources or resource types identified at block 1002 may be generated. This list of executables may be extracted by traversing association table 402 for links into execution table 410 and or the class table 412. Alternately, association manager 224 may maintain a subscription table which identifies which resource-executable pairs contain event handler executables and optionally the events handled by the event handler.

At block 1006, persistent information elements associated with each event handler executable via the event handler's resource-executable pair is accessed by traversing association table 402 to the event handler record in either executable table 410 or the class table 412, then locating the persistent property elements in property instance table 404 via the linkages between the executable record or class record and their associated persistent property elements.

At block 1008, association manager 224 may invoke event handler executable(s) identified at block 1004, using the identified persistent information element(s) identified at block 1006, and using the identified impacted resource or resource group. An event handler may use an impacted resource during its processing or it may not. An event handler may perform any function allowed by the system and the resources including persistent information elements to which it has access.

A system for associating a persistent information element with a resource-executable pair may include means for associating a computer system resource with an executable to form a resource-executable pair. For example, association manager 224 may be used to populate, maintain, and access associations maintained in association table 402. Further, as noted in FIG. 6, these tables may be instantiated through a system GUI using blocks 602, 604, 606, 608, and 618 of exemplary process 600. These records may be maintained by association manager 224 in association library 202, and a copy may be stored in a system persistent memory data storage medium 204, as shown in FIG. 2.

The system may also include means for associating a persistent information element with the named resource-executable pair and storing the persistent information element independently from the resource and the executable in a manner that survives termination of a first instantiation of the executable. For example, in FIG. 4, a property instance table 404 may contain a series of records with persistent information elements assigned to the resource-executable pair named in association table 402. The contents of property instance table 404 may be organized into sub-table groups as noted in FIG. 5, including location sub-table 506, association sub-table 508, and element sub-table 510. Further, as noted in FIG. 6, property instance table may be instantiated for each persistent information element through a system GUI using blocks 610, 612, 614, and 616 of exemplary process 600. These records may be maintained by association manager 224 in association library 202, and a copy may be stored in a system persistent memory data storage medium 204, as shown in FIG. 2.

The system may also include means for providing for performing an operation on or using the persistent information element with a second instantiation of the executable. For example, association manager 224 may provide the persistent information element for system resources 206, 210, 214, 216, and 220 to use as an input variable, as an output variable, or both.

### Applications

One application of the subject matter described herein may allow the user of a personal computer to associate a text editing resource with a graphics drawing resource. For example, a user may wish to maintain a set of resource-executable associations in an association library 202 to open a Microsoft Visio graphics file when an associated Microsoft Word text file is accessed. The user may write an executable script file that, when given a file resource, determines its name and produces a set of strings by taking the resource filename's file type and adding a list of suffixes reference by the script to the resource file name. Thus, if the script associated with a file named myDisclosure.doc and its suffix list reference contains the suffix “.vsd”, the script produces a string named “myDisclosure.vsd” and stores it in its internal string variable. The script may be extended to call the library's defaultaction executable passing in the strings produced by the user's script and also uses it to invoke the default action on the resource.

Once created, the script may be registered in an association library 202, which subsequently associates a persistent element of type string to store the file suffixes. The user may then access association library 202 through an appropriate UI to set an additional condition that the requested text and graphics files must be in a certain set of file folders. The UI may display a list of executables that are permitted to be associated with the set of files of interest, and the user may then select the executable script. Upon selection, association library 202 may determine from the descriptor provided with the script that persistent information elements of type string list are associated with the script. A list of all elements of type string list may then be presented at the UI. The user may then either select a predefined string list element or create a new string list element to be associated with the resource-executable pair. Once the persistent information element is associated with the resource-executable pair, the user may name the association “open as disclosure” and choose “context menu” as the location where a visual representation should be presented, thus completing the process of defining the resource-executable pair instantiation. The user may now right click on a .doc file and will be presented with an “open as disclosure” context menu tab. When the “open as disclosure” tab is activated, association manager 224 may cause the .doc file to open and also open a .vsd file with a matching name. The user may then associate the same executable with the .vsd file type and creates a string list persistent information element instance containing the string “.doc” for this association, thus permitting the executable script to open a .doc file when a .vsd file is invoked.

Another application of the subject matter described herein may allow a system operator to use an executable script and persistent information elements to maintain a list of users accessing a specific system resource. For example, a system operator may have a need to monitor use of an application software package that is leased from a vendor, in order to determine if the software package is sufficiently utilized to justify the cost of the lease. In this instance, the operator may provide an executable script that passively copies the user identification information into a persistent information element structured as a string list when the target resource is instantiated and then has no further interaction with the resource. The system operator may then access the recorded list in association library 224 to obtain the names without requiring any interaction with either the resource or users.

Another application of the subject matter described herein may allow a system operator to use an executable script and persistent information elements to record a list of times that the resource is accessed in order to monitor system utilization throughout the day. The executable script and association library operations for this use may be an extension of the executable script and operations defined for maintaining a list of users accessing a specific system resource.

Another application of the subject matter described herein may allow a resource or a user to examine a persistent information element value set by another resource and then take some predefined action. For example, an executable script may be loaded into association library 202 that examines a persistent information element maintaining a count of the number of times a system resource is instantiated. Association library 202 may contain one executable script associated with the target resource to passively increment a value in the persistent information element containing a count of the number of times the target resource is activated. A second script activated by a system time or alarm event may then passively retrieve the count value in the persistent information element and take some action deemed appropriate by the author of the executable script. Response actions may include blocking further instantiations of the target resource or sending a notification message to an appropriate destination.

Another application of the subject matter described herein may allow an executable script associated with a resource to autonomously monitor system resource associations defined by a user for a target resource and then enable subsequent accesses to those system resources. For example, a user may open a text file and a series of graphics editing files. The user may then use local resource cut and paste operations at the UI to place a copy of the contents of the graphics files into the text file. The executable associated with the text file may capture the names of the graphics files in persistent information element(s) of type string list. Upon subsequent accesses to the text editing resource, the executable may check the persistent information element(s) and autonomously open any listed graphics files.

### Enhancements

In one enhancement of the subject matter described herein, a persistent information element may be modified in response to instantiation of an executable that is not included in the resource-executable pair with which the persistent information element is associated. For example, a transmission counter may be associated with a word processor-document file and may be incremented each time the document is transmitted over a network.

In another enhancement of the subject matter described herein, a persistent information element may be associated with a plurality of resource-executable pairs. For example, a persistent information element may be defined by a plurality of executable scripts to contain certain attribute values for a GUI such as background color. One executable script may provide UI support to permit a user to set the attribute values. Executable scripts paired with a variety of resources within a product family, such as the various members of the Microsoft Office suite of products, may read the persistent information element and present the attribute value(s) to the resource during the resource instantiation process.

In yet another enhancement of the subject matter described herein, an association among resources, executables, and persistent information elements with common type definitions may be implemented using a class. For example, a class may be defined for all executables and persistent information elements associated with a spreadsheet resource. One executable may bind visual basic macros stored in persistent information elements of type string list into the spreadsheet at instantiation, while a second executable may enable a graphic resource to capture equations in algebraic form for the spreadsheet to process.

In yet another enhancement of the subject matter described herein, a persistent information element may be a component of a class, which may in turn be referenced or utilized by a second class. For example, a persistent information element may be defined to contain a specific attribute value for a UI display. All of the elements and associated executables pertaining to the UI display may be contained in a UI class. A second class may be defined to contain references for all executables, persistent information elements, and class that have a bearing on a given system resource such as an email client. When the email client resource is instantiated, association manager 224 would invoke the class defined for the email client and run all defined executables, including executables that would reference the UI display attribute persistent information elements in UI object.

In yet another enhancement of the subject matter, a container class may be defined to contain a plurality of persistent information element references, executable script references, and system resource references associated with a given resource-executable pair. For example, a container class may be defined for a software compiler tool that would contain references to a source code library management resource, a debugging tool resource, or an emulation tool resource in addition to any executable scripts and persistent information elements assigned to the class for use when the compiler tool is invoked.

### Exemplary Advantages

The subject matter described herein, when applied to a host computer system 200, may permit consistent UI context menu presentations to a UI within an instantiation of a system resource. For example, context menus presented within an instantiation of a system resource may provide a user with access to local methods supported in the resource as well as to persistent information elements or methods stored in an association library 202 outside the context control of the resource. Context menu executables may then support use of stateful information that persists beyond the termination of the resource instance, and may also be defined to respond to resource-related events. A UI may also be implement which allows users to create new sets of executables and properties (i.e. classes) and associate them with a resource or resources.

The subject matter described herein, when applied to a host computer system 200, may permit classes to be defined and maintained in an association library 202 outside the context control of any system resource. For example, a user may wish to define implicit relationships among resources with shared type definitions or persistent information element assignments, and class definitions for association, aggregation, and containment relationships may be created. Class level executables and properties may enable data and executables to be associated with every resource the class has been associated with. Class definitions may be structured to optimize searches for resources, executables, or persistent information elements of a predefined type. Classes may support single or multiple inheritances to simplify the process of defining classes containing large groups of executables or persistent information elements. Classes, executables, and persistent information elements may be directly accessed through a GUI without having an active instance of the associated resource present in the system, simplifying the process of instantiating or maintaining the contents of association library 202.

The subject matter described herein, when applied to a host computer system 200, may allow a computing system to be extended. For example, users may readily create and use relationships among resource accessible to the system to automate tasks, create new navigation tools, and make the system easier to use. The subject matter described herein may also cause a market to be created for sets of executables and properties that may be shared as represented by many devices using existing installation mechanisms.

It will be understood that various details of the subject matter described herein may be changed without departing from the scope of the subject matter described herein. Furthermore, the foregoing description is for the purpose of illustration only, and not for the purpose of limitation, as the subject matter described herein is defined by the claims as set forth hereinafter.

What is claimed is:

1. A method for associating a persistent information element with a resource-executable pair, the method comprising:
(a) associating a computer system resource with an executable to form a resource-executable pair;
(b) associating a persistent information element with the resource-executable pair and storing the persistent information element independently from the resource and the executable in a manner that survives termination of a first instantiation of the executable; and
(c) providing for performing an operation on or using the persistent information element with a second instantiation of the executable.

2. The method of claim 1 wherein associating a computer system resource with an executable includes associating the computer system resource with a class that includes the executable to form a resource-class pair.

3. The method of claim 1 wherein associating a computer system resource with an executable includes associating a group of computer system resources with the executable to form a resource group-executable pair.

4. The method of claim 1 wherein associating a computer system resource with an executable includes associating a group of computer system resources with a class that includes the executable to form a resource group-class pair.

5. The method of claim 1 further comprising providing for performing an operation on or using the persistent information element in response to an instantiation of an executable not included in the resource-executable pair.

6. The method of claim 1 wherein associating a computer system resource with an executable and associating the persistent information element with the resource-executable pair includes adding an identifier to a context menu associated with the computer system resource to trigger execution of the executable and performance of the operation.

7. The method of claim 1 wherein associating a computer system resource with an executable and associating a persistent information element with the resource-executable pair and includes providing an application programming interface (API) for making the associations.

8. The method of claim 1 wherein associating a persistent information element with the resource-executable pair and storing the persistent information element includes the storing the persistent information element in a data store maintained in persistent media and linking the resource-executable pair to the persistent information element via the data store.

9. The method of claim 8 wherein storing the persistent information element in the persistent media includes storing the persistent information element in a manner such that the persistent information element is associated with a plurality of different resource-executable pairs.

10. The method of claim 1 wherein the persistent information element comprises an input data variable for the executable and wherein providing for performing an operation on or using the persistent information element includes providing the input data variable as input to the executable.

11. The method of claim 1 wherein the persistent information element comprises an output data variable and wherein providing for performing an operation on or using the persistent information element includes changing a value of the output data variable using the executable.

12. A method for associating a persistent information element with a resource-class pair, the method comprising:
(a) associating a computer system resource with a class including a plurality of executables to form a resource-class pair;
(b) associating a persistent information element with the resource-class pair and storing the persistent information element independently from the resource and the class executables in a manner that survives termination of an instantiation of the class; and
(c) providing for performing an operation on or using the persistent information element using an executable of the class.

13. The method of claim 12 wherein the persistent information element comprises a class element associated with the class and wherein the class element is available to all class executables for performing the operation.

14. The method of claim 12 wherein providing for performing an operation on or using the persistent information element includes invoking one class executable with another class executable using the persistent information element.

15. The method of claim 12 wherein the class comprises a container class including an executable element for displaying a plurality of system resources that are associated with the resource-class pair.

16. A system for associating a persistent information element with a resource-executable pair, the system comprising:
(a) a persistent information element data store for storing a persistent information element independently from a computer system resource and an executable that form a resource-executable pair in a manner that survives termination of a first instantiation of the executable that is associated with the resource-executable pair; and
(b) an association manager for providing for performing an operation on or using the persistent information element with a second instantiation of the executable.

17. The system of claim 16 wherein the association manager is adapted to perform an operation on or using the persistent information element in response to an instantiation of an executable not included in the resource-executable pair.

18. The system of claim 16 wherein the association manager is adapted to associate the resource with the executable and the persistent information element with the resource-executable pair using a context menu associated with the system resource.

19. The system of claim 16 comprising an application programming interface (API) for allowing an application to associate the resource with the executable to form the resource-executable pair and for associating the persistent information element with the resource-executable pair.

20. The system of claim 16 wherein the persistent information element data store is adapted to maintain the association between the persistent information element and the resource-executable pair in persistent media.

21. The system of claim 16 wherein the persistent information element data store is adapted to link the persistent information element to a plurality of different resource-executable pairs.

22. The system of claim 16 wherein the persistent information element comprises an input data variable and wherein the association manager is adapted to provide the input data variable to the executable as input.

23. The system of claim 16 wherein the persistent information element comprises an output data variable and wherein the association manager is adapted to store, in the persistent information element data store, a value of the output data variable modified by the executable.

24. A system for associating a persistent information element with a resource-class pair, the system comprising:
(a) a persistent information element data store for storing a persistent information element independently from a computer system resource and a class including a plurality of executables that form a resource-class pair in a manner that survives termination of a first instantiation of the class; and
(b) an association manager for providing for performing an operation on or using the persistent information element with a second instantiation of the class.

25. The system of claim 24 wherein the persistent information element comprises a class element associated with the class and wherein the class element is available to all class executables for performing the operation.

26. The method of claim 24 wherein providing for performing an operation on or using the persistent information element includes invoking one class executable with another class executable using the persistent information element.

27. The system of claim 24 wherein the class comprises a container class including a container element for displaying a plurality of system resources associated with the resource-class pair.

28. A system for associating a persistent information element with a resource executable pair, the system comprising:
(a) means for associating a computer system resource with an executable to form a resource-executable pair;
(b) means for associating a persistent information element with the resource-executable pair and storing the persistent information element independently from the resource and the executable in a manner that survives termination of a first instantiation of the executable; and
(c) means for providing for performing an operation on or using the persistent information element with a second instantiation of the executable.

29. A computer program product comprising computer executable instructions embodied in a computer readable medium for performing steps comprising:
(a) associating a computer system resource with an executable to form a resource-executable pair;
(b) associating a persistent information element with the resource executable pair and storing the persistent information element independently from the resource and the executable in a manner that survives termination of a first instantiation of the executable; and
(c) providing for performing an operation on or using the persistent information element with a second instantiation of the executable.
